(19) United States
(12) Patent Application Publication
(10) Pub. No.: US 2015/0292648 A1
(43) Pub. Date: Oct. 15, 2015

(54) Trap-a-cord, an apparatus that provides a method for holding cords in place

(71) Applicant: Carlos Jimenez, Oceanside, CA (US)

(72) Inventor: Carlos Jimenez, Oceanside, CA (US)

(21) Appl. No.: 13/999,959

(22) Filed: Apr. 10, 2014

(51) Int. Cl. F16L 3/10; F16L 3/23

(52) U.S. Cl. CPC F16L 3/1075; F16L 3/23

(57) ABSTRACT

Unlike prior art, the present invention is novel in that it avails itself equally to interior and external surface applications accommodating a variety of cords such as string, ribbon or low voltage electrical cords, by gripping and holding cords securely within the present invention's triangular, serrated ridges. The present invention can be utilized singly for individual single applications or in plurality as needed to secure longer spans of cords. This novel invention provides consumers a more ascetically pleasing, and a wider range of flexibility, for cord management for short, or extended periods of time. This invention enables the user to temporarily sustain celebratory signs or ribbon held balloons on walls, chairs or other fixture's surfaces by the installation of double backed tape on the underside. More permanent installations such attaching low voltage ornamental lighting on interior or exterior surfaces can be accomplished by placing a wood screw or small nail through the bottom of the device.

### CROSS REFERENCE TO RELATED APPLICATIONS

Provisional Patent No. 61/854,792

### STATEMENT REGARDING FEDERALLY SPONSORED RESEARCH OR DEVELOPMENT

Not Applicable

### BACKGROUND OF THE INVENTION

1. Field of the Invention

The present Invention relates to art class 24, and is in the field of devices for managing cords. In particular, this invention pertains to management of cords such as thread, string, lace, ribbon, wire, twine, yarn, elastic, cable, etc; on varied exterior and interior surfaces. More specifically this device can be used as a single unit or in plurality.

2. Description of Prior Art

Prior art search reveals a wide range of submissions for cord management devices such as Marvin G. Stock, U.S. Pat. No. 3,193,229A, which describes a hanger for a string of lights on an exterior of a structure, or Simon Paul J., U.S. Pat. No. 2,746,112, in which the invention describes a device with an ability to hold loose or excess lengths of cords, primarily onto baseboards. William E. Adams, U.S. Pat. No. 5,141,192 A, cites an apparatus for hanging cords from a gutter or the like, making reference to exterior applications. The latter prior art suggests to wind cords through a maze of coils. Its apparent that prior art does not make itself convenient for use with other cord elements such as string or ribbon nor does it provide an effective and aesthetic means for cord management within interior applications. Other examples of prior art include Trueson, U.S. Pat. No. 3,189,310, Campbell, U.S. Pat. No. 3,275,818, Van Ess, U.S. Pat. No. 4,244,014. All of the cited examples primarily present devices for exterior applications are labor intensive to install, obtrusive, are not aesthetically pleasing and do not provide a means to keep a variety of cords in place and taut for a more effective and better aesthetic appearance.

### BRIEF SUMMARY OF THE INVENTION

It is typical for a consumer, home owner, or tenant of a residence to seek a temporary or more permanent solution for the management, arrangement or installation of loose or suspended low voltage electrical cords such as ornamental lighting or many other varieties of cords such as yarn, string signs or ribbon strung balloons. Residents are careful to guard against damage caused by U-shaped staples, push pins or nail holes on interior walls or their building's facia, often resorting to what ever is first available or more conveniently at hand. It's common to see previous years of ill residual affects in the form of bent nails, screw posts, or broken plastic clips throughout the perimeter of a home or pin holes on interior walls in their determination to hang ornamental lights. Over the years attempts for better cord management results in unsightly, rusted hardware damaged interior walls, rafters and roof flashing. The present invention is different from prior art in that it provides the consumer an alternative, convenient, more efficient and better aesthetically pleasing method for cord management equally functional on interior or exterior surfaces temporarily or for longer term use. The present invention's construction is of robust plastic or light weight metal material that lends to a device that is better suited for interior use than its predecessors and as identified in the prior art. Application or installation is intuitive and simple by means of adhesive tapes or a small nail or screw and serviceable as a single unit or in plurality. Once installed this new novel invention can be left in place for convenient and multiple application reuse. This invention is particularly useful in an application or installation of a home's eves, whereby the device occupies the edge of a facia board, or can be installed on the underside of the eve's facia board hidden from view.

### BRIEF DESCRIPTION OF THE SEVERAL VIEWS OF THE DRAWING

FIG. 1, is a perspective top side angular view of the present invention. The top side angular view shows the device folded at its mid point with both ends engaged showing the embodiment of the invention as one unit in use with an example of a low voltage cord entrapped within and upon the triangular serrated ridges of the device.

FIG. 2, is a perspective side view of the embodiment of the invention, showing the device in a closed position as described in FIG. 1 the top interior of the invention engaged with the bottom interior by means of pressing together or interlocking the top end to the bottom, placing pressure upon the cord within the device thereby trapping the cord onto and upon the triangular serrated ridges.

FIG. 3, is a perspective front and side angular view of the present invention, depicting the device in an opened configuration to better illustrate the interior top and interior bottom first and second ends latching methodology as well as a plurality of triangular serrated ridges upon the center of the device's bottom interior.

FIG. 4, is a perspective top view of the embodiment of the present invention shown laying flat in an open and unfolded position.

FIG. 5, is a perspective side view of the invention, wherein the device is depicted in its entire length with a first and second end, each end having an interlocking capability when engaged and the device having a scored or heat pressed living hinge at its midway point to facilitate folding the device in half as shown in FIGS. 1 and 2.

FIG. 6, is a perspective bottom view of the device, wherein the device has a hole on the bottom to accommodate a small wood screw or nail and also shows the bottom exterior constructed of a more dense or thicker material providing a more sturdy bottom suitable for accommodating a small screw, nail or various types of adhesive tapes.

### DETAILED DESCRIPTION OF THE INVENTION

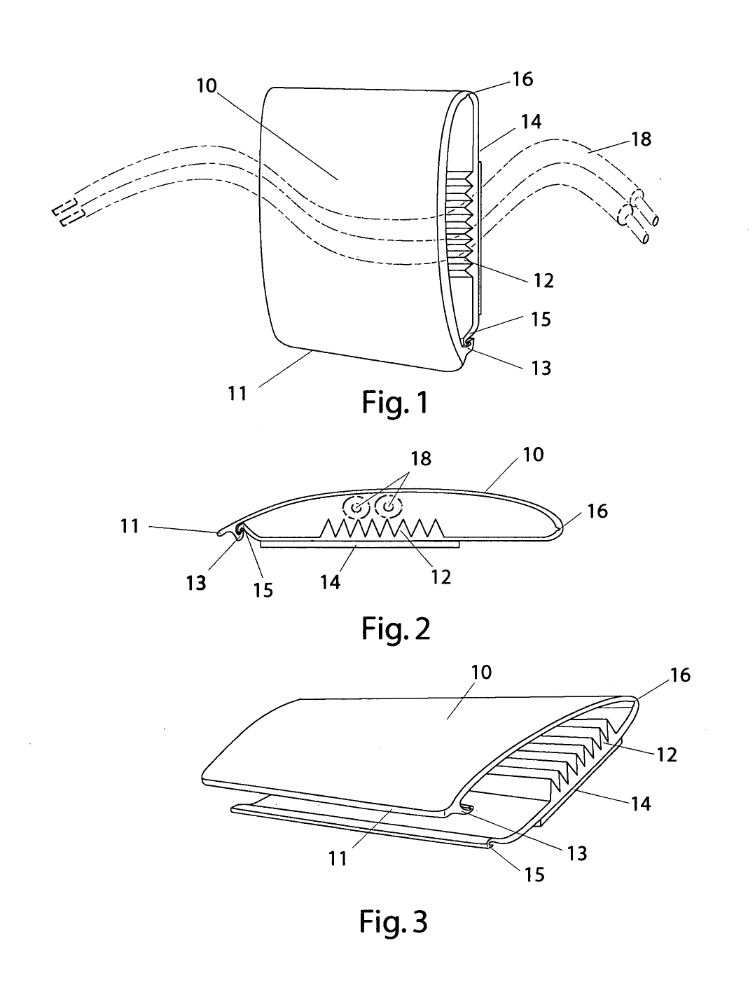

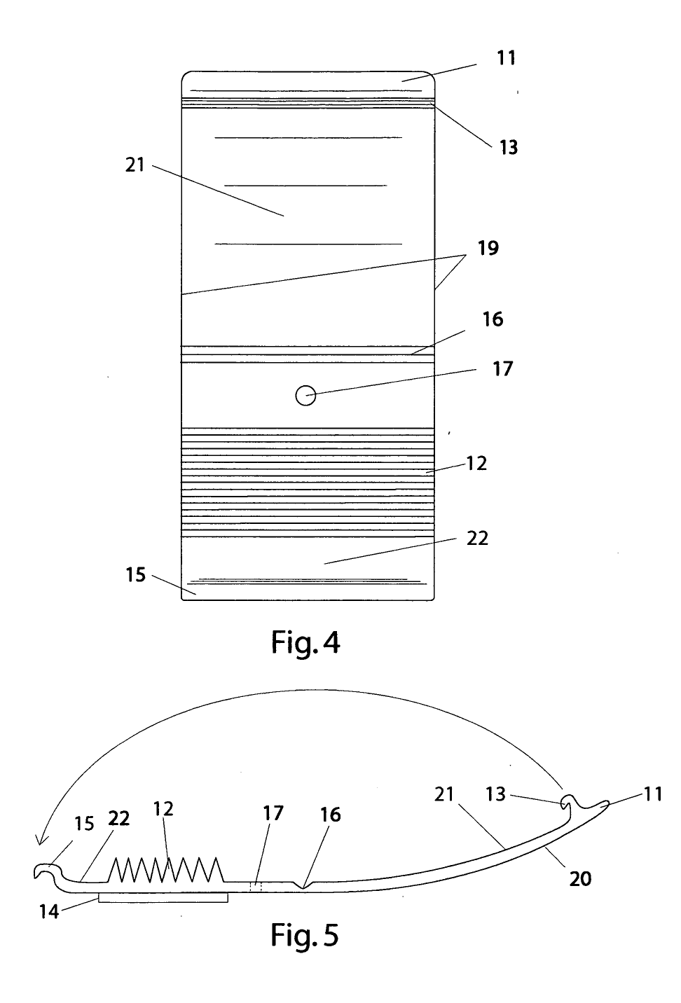

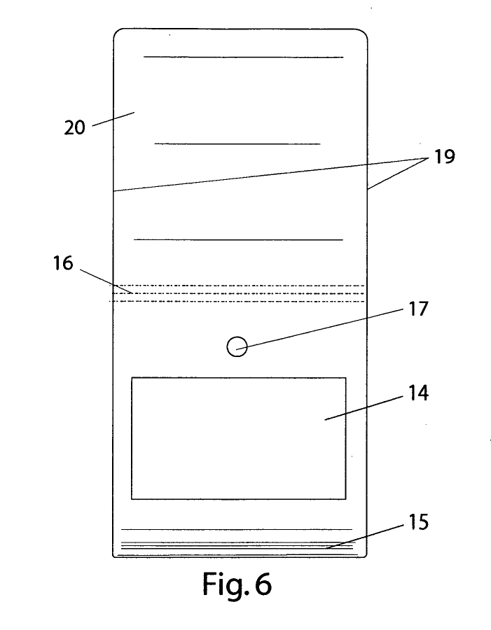

The present invention pertains to a novel device or apparatus FIG. 1.10, constructed of plastic composite or light weight metal material. Dimensions provided in the preferred embodiment of FIG. 1 through 6 represent an approximate depiction of the device. A more descriptive view of the device will be more apparent in the following detailed description of the invention. In FIG. 1 the device shown folded in half is comprised of a unit approximately three inches in length and one inch wide 19 having a first and a second end 11 and 15 each with interlocking capability 13 and 15 so as to provide a means for engagement of the first end to the second end when the two ends are pressed together, and two longitudinal parallel edges FIG. 4.19 The device possessing a scored or heat pressed living hinge 16 at the midway point so as to facilitate a means by which the unit is to be folded in half as shown in FIGS. 1, 2 and 3. When the device is closed by folding in half as indicated in FIGS. 1, 2 and 3 by engaging the first and second ends 11 and 15 together, the results produce a top interior surface FIG. 5. 21 and top exterior surface FIG. 5. 20 of the device. The center of the bottom exterior surface 14 is more robust and of a thicker construction to provide a sturdier base for the bottom interior surface FIG. 5. 22 having a plurality of triangular serrated ridges 12 oriented perpendicular to and from end to end to the parallel longitudinal edges FIG. 4.19. The serrated plurality of triangular serrated ridges 12 will be of sufficient height to allow the tips of the serrated triangular ridges 12 to engage the top interior surface 21 of the device 10 resulting in the top of the device to arc or bend conforming onto and trapping the cord 18 between the triangular serrated ridges and the top interior 21 as shown in FIGS. 1 and 2. Installation or use of the present invention is intuitive, affixing the device to an interior surface by means of double backed adhesive tape applied to the bottom exterior of the device shown as FIG. 6.14 More permanent installations can be accomplished by using a small screw or fastener inserted into a hole FIG. 4.17 provided on FIG. 4.14 of the device. Once installed the present invention FIG. 2 presents a low profile, blending into the surrounding surface, completely unobtrusive. The device can be painted over to match the surrounding color and can be left in place permanently. Cords can be easily placed within the present invention by simply placing the cord 18 within the plurality of serrated triangular ridges, FIG. 1.12 of the device and pressing the top first end 13 onto the bottom second end 15 thereby latching the device closed FIG. 2 and allowing the cord 18 to be trapped and held tightly within the device. Removal of the cord 18 is simple by unlatching the first end 13 on top exterior surface 20 from the second end 15 of the bottom exterior surface 14 causing the cord 18 to drop away from the device 10. After the cord 18 drops away from the device 10 the user simply reengages the front and second end of the device FIG. 2 until such time that it will be used another time. It's common in this art field that little or no importance is given to aesthetics and care for surfaces where cord management devices are placed particularly when installing devices such as this on interior surfaces.

This device FIG. 1 will be manufactured of a light weight metal or through plastic injection molding of material that is sufficiently robust to assure longevity when used outside and aesthetically pleasing when used indoors. As shown in FIG. 2 the low profile attribute provides users the ability to place the present invention inconspicuously, temporarily or permanently without damaging valuable assets.

I claim:

1. A cord management device for holding or suspending cords securely on interior or exterior surfaces the device comprising; a top exterior and interior and a bottom interior and exterior a first end and a second end wherein the device is plastic or light weight metal of a rectangular flat dimension with a plurality of triangular serrated ridges oriented towards the width of the bottom interior wherein the device is scored at the midpoint from one longitudinal edge to the other to facilitate folding the top of the device over the bottom of the device having a first and second end and a top and bottom side and each end having the capability of interlocking when pressed together

2. A device as described in claim 1 wherein the device can be manufactured of plastic or light weight metal.

3. A device as described in claim 1 with a plurality of triangular serrated ridges wherein the serrated triangular ridges come in contact with the top interior of the device trapping the cord within when the device is closed.
